(19) United States
(12) Patent Application Publication
(10) Pub. No.: US 2026/0068885 A1
(43) Pub. Date: Mar. 12, 2026

(54) HERBICIDAL COMPOSITIONS

(71) Applicant: BAYER AKTIENGESELLSCHAFT, Leverkusen (DE)

(72) Inventors: Elmar Gatzweiler, Leverkusen (DE); Christian Waldraff, Leverkusen (DE); Arnim Köhn, Leverkusen (DE); Harald Jakobi, Leverkusen (DE); Hartmut Ahrens, Leverkusen (DE); Klaus Trabold, Leverkusen (DE)

(21) Appl. No.: 19/106,056

(22) PCT Filed: Aug. 15, 2023
(86) PCT No.: PCT/EP2023/072430

§ 371 Date: Feb. 24, 2025

(30) Foreign Application Priority Data
Aug. 25, 2022 (EP) 22192057.2

(51) Int. Cl. A01N 43/82; A01N 43/36; A01N 43/40; A01N 43/54; A01N 43/56; A01N 43/58; A01N 43/80; A01N 43/84; A01P 13/00

(52) U.S. Cl. CPC A01N 43/82; A01N 43/36; A01N 43/40; A01N 43/54; A01N 43/56; A01N 43/58; A01N 43/80; A01N 43/84; A01P 13/00

(57) ABSTRACT

Herbicidal compositions are described, comprising an N-(1,3,4-oxadiazol-2-yl)arylcarboxamide and further herbicides.

The present invention relates to agrochemically active herbicidal compositions, to processes for production thereof and to the use thereof for control of harmful plants.

WO2015/059187 A1 discloses herbicidal compositions comprising N-(1,3,4-oxadiazol-2-yl)arylcarboxamides.

This also describes herbicidal compositions comprising 2-chloro-N-(5-methyl-1,3,4-oxadiazol-2-yl)-3-(methylsulfinyl)-4-(trifluoromethyl)benzamide in racemic form as Example No. A1-14.

However, the herbicidal compositions known from WO2015/059187 A1 often have an unfavourable profile with regard to their biological properties, such as herbicidal action, tolerance by crop plants, toxicological and ecotoxicological properties.

It is an object of the present invention to provide alternative herbicidally active compositions. This object is achieved by the herbicidal compositions of the invention comprising a particular N-(1,3,4-oxadiazol-2-yl)arylcarboxamide that are described hereinafter.

The present invention provides herbicidal compositions comprising
(A) the compound having the absolute configuration (component A) specified in formula (I-5) or salts thereof

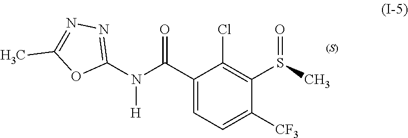

and
(B) one or more herbicides (component B) selected from groups B1, B2, B5, B6, B8 and B9:
B1: dioxopyritrione, benquitrione, tolpyralate, lancotrione,
B2: methyl (2R*,4R*)-4-[[(5S)-3-(3,5-difluorophenyl)-5-vinyl-4H-isoxazole-5-carbonyl]amino]tetrahydrofuran-2-carboxylate, methyl (1S,4R)-4-[[(5S)-3-(3,5-difluorophenyl)-5-vinyl-4H-isoxazole-5-carbonyl]amino]cyclopent-2-ene-1-carboxylate, dimesulfacet,
B5: trifludimoxazin, tetflupyrolimet, fenpyrazone, florpyrauxifen, bixlozone,
B6: 4-amino-3-chloro-5-fluoro-6-(7-fluoro-1H-indol-6-yl)pyridine-2-carboxylic acid,
B8: rimisoxafen,
B9: tiafenacil, flufenoximacil, ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate.

In a further embodiment, these herbicidal compositions comprise (C) one or more safeners (component C) from the group consisting of
benoxacor (C1), cloquintocet-mexyl (C2), cyprosulfamide (C3), dichlormid (C4), fenclorim (C5), fenchlorazole (C6), furilazole (C7), isoxadifen-ethyl (C8), mefenpyr-diethyl (C9), 4-(dichloroacetyl)-1-oxa-4-azaspiro[4.5]decane of CAS 71526-07-3 (C10), 2,2,5-trimethyl-3-(dechloroacetyl)-1,3-oxazolidine of CAS 52836-31-4 (C11).

Components B) and C) are known, for example, from “The Pesticide Manual”, 19th edition, The British Crop Protection Council and the Royal Soc. of Chemistry, and from the website http://www.alanwood.net/pesticides/. Methyl (2R*,4R*)-4-[[(5S)-3-(3,5-difluorophenyl)-5-vinyl-4H-isoxazole-5-carbonyl]amino]tetrahydrofuran-2-carboxylate is known, for example, from WO2018/228985 A1. Methyl (1S,4R)-4-[[(5S)-3-(3,5-difluorophenyl)-5-vinyl-4H-isoxazole-5-carbonyl]amino]cyclopent-2-ene-1-carboxylate and ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate are known, for example, from WO2019/145245 A1.

Preferred components B are the following herbicides:
B1: dioxopyritrione, benquitrione, tolpyralate,
B2: methyl (2R*,4R*)-4-[[(5S)-3-(3,5-difluorophenyl)-5-vinyl-4H-isoxazole-5-carbonyl]amino]tetrahydrofuran-2-carboxylate, methyl (1S,4R)-4-[[(5S)-3-(3,5-difluorophenyl)-5-vinyl-4H-isoxazole-5-carbonyl]amino]cyclopent-2-ene-1-carboxylate,
B5: trifludimoxazin, tetflupyrolimet, fenpyrazone, florpyrauxifen, bixlozone,
B6: 4-amino-3-chloro-5-fluoro-6-(7-fluoro-1H-indol-6-yl)pyridine-2-carboxylic acid,
B8: rimisoxafen,
B9: tiafenacil, flufenoximacil, ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate.

Particularly preferred components B are the following herbicides:
B1: dioxopyritrione, benquitrione, tolpyralate,
B2: methyl (2R*,4R*)-4-[[(5S)-3-(3,5-difluorophenyl)-5-vinyl-4H-isoxazole-5-carbonyl]amino]tetrahydrofuran-2-carboxylate, methyl (1S,4R)-4-[[(5S)-3-(3,5-difluorophenyl)-5-vinyl-4H-isoxazole-5-carbonyl]amino]cyclopent-2-ene-1-carboxylate,
B5: trifludimoxazin, tetflupyrolimet, fenpyrazone, florpyrauxifen,
B6: 4-amino-3-chloro-5-fluoro-6-(7-fluoro-1H-indol-6-yl)pyridine-2-carboxylic acid,
B8: rimisoxafen,
B9: tiafenacil, flufenoximacil, ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate.

The herbicidal compositions according to the invention may comprise or be used together with additional further components, for example other kinds of active crop protection ingredients and/or additives and/or formulation auxiliaries customary in crop protection.

The herbicides (A), (B) and any safeners (C) can be applied in a known manner, for example together (for example as a co-formulation or as a tank-mix) or else at different times in short succession (splitting), for example to the plants, plant parts, plant seeds or the area on which the plants grow. It is possible, for example, to apply the individual active ingredients or the herbicide-safener combination in several portions (sequential application), for example by pre-emergence applications followed by post-emergence applications, or by early post-emergence applications followed by post-emergence applications at an intermediate or late stage. Preference is given to the joint or immediately successive application of the active ingredients in the respective combination. It is also possible to use the individual active ingredients or the herbicide-safener combination for seed treatment.

The application rate of component (A) in the herbicidal compositions according to the invention is typically 0.01 to 200 g a.i./ha, preferably 0.02 to 150 g a.i./ha, more preferably 0.05 to 120 g a.i./ha.

The application rate of component (B) in the herbicidal compositions according to the invention is typically 0.01 to 400 g a.i./ha, preferably 0.05 to 300 g a.i./ha, more preferably 0.1 to 200 g a.i./ha.

On application of the herbicidal compositions according to the invention, a very broad spectrum of harmful plants is controlled pre-emergence and post-emergence, for example annual and perennial mono- or dicotyledonous weeds and unwanted crop plants. The herbicidal compositions according to the invention are particularly suitable for use in crops such as cereals, maize, rice, soya, oilseed rape, sugar beet, cotton, sugar cane, and also for use in perennial crops, plantations and on uncultivated land. They are likewise highly suitable for use in transgenic crops of corn, cereals, sugar beet, rice, cotton and Glycine max. (e.g. RR soya or LL soya) and crossbreeds thereof), Phaseolus, Pisum, Vicia and Arachis, or vegetable crops from various botanical groups such as potato, leek, cabbage, carrot, tomato, onion, and also perennial and plantation crops such as pome fruit and stone fruit, soft fruit, wine, Hevea, bananas, sugar cane, coffee, tea, citrus, nut plantations, lawn, palm crops and forest crops. For the use of the inventive herbicide-safener combinations (A)+(B), these crops are likewise preferred, particular preference being given to use in cereals (e.g. wheat, barley, rye, oats), rice, corn, millet/sorghum, sugar beet, sugar cane, sunflower, oilseed rape and cotton. The herbicide-safener combinations (A)+(B) can also be used in tolerant and non-tolerant mutant crops and tolerant and non-tolerant transgenic crops, preferably of corn, rice, cereals, oilseed rape, cotton, sugar beet and soya, for example those resistant to imidazolinone herbicides, atrazine, glufosinate, glyphosate, 2,4 D, dicamba and herbicides from the group of the inhibitors of hydroxyphenylpyruvate dioxygenase, such as sulcotrione, mesotrione, tembotrione, tefuryltrione, benzobicyclon, bicyclopyrone and ketospiradox.

“Herbicidally active amount” in the sense of the invention is an amount of one or more herbicides suitable for having an adverse impact on plant growth. “Antidotically active amount” in the sense of the invention means an amount of one or more safeners suitable for reducing the phytotoxic effect of active compounds of crop protection compositions (for example of herbicides) on crop plants.

According to their properties, the safeners (C) present in the inventive herbicidal compositions can also be used for pretreatment of the seed of the crop plant (for example for dressing of the seed) or introduced into the seed furrows prior to sowing or employed together with the herbicide prior to or after emergence of the plants. Pre-emergence treatment includes both the treatment of the area under cultivation (including any water present in the area under cultivation, for example in the case of applications to rice) prior to sowing and the treatment of the areas under cultivation in which seeds have been sown but which are not yet covered by growing plants. Preference is given to application together with the herbicide. For this purpose, it is possible to use tank-mixes or ready-made formulations.

In a preferred embodiment, the seed (for example grains, seeds or vegetative propagation organs such as tubers or budded parts of shoots) or seedlings are pretreated with the safeners (C), optionally in combination with other active agrochemical ingredients. For pretreatment of the seed, the active compounds can be applied to the seed, for example by dressing, or the active compounds and the seed can be added to water or other solvents, and the active compounds can be taken up, for example, by adsorption or diffusion in a dipping process or by swelling or pre-germination. For pretreatment of seedlings, the young plants can be contacted with the safeners, optionally in combination with other active agrochemical ingredients, for example by spraying, dipping or watering, and then transplanted and optionally aftertreated with the herbicides (A) and (B).

The seed or seedlings can be treated with the safeners (C) alone or together with other active agrochemical ingredients—such as fungicides, insecticides or plant fortifiers, fertilizers or swelling and germination accelerators. After the pretreatment application, the safeners may subsequently be applied once again before, after or together with the herbicide of the formula (I-5) (A) and the herbicides (B), possibly also in combination with other known herbicides. The pretreatment of the seed or seedlings can achieve improved long-term efficacy of the safeners.

The present invention thus further provides a method of controlling unwanted plants in plant crops, which is characterized in that the components (A), (B) and optionally (C) of the herbicidal compositions according to the invention to the plants (for example harmful plants, such as monocotyledonous or dicotyledonous weeds or unwanted crop plants), the seed (for example grains, seeds or vegetative propagation organs, such as tubers or budded parts of shoots) or the area on which the plants grow (for example the area under cultivation), for example together or separately. One or more safeners (C) may be applied before, after or simultaneously with the herbicide of the general formula (I-5) (A) and the herbicides (B) to the plants, the seed or the area on which the plants grow (for example the area under cultivation). In a preferred embodiment, the safeners (C) are used for seed treatment.

Unwanted plants are understood to mean all plants growing at sites where they are unwanted. These may, for example, be harmful plants (for example monocotyledonous or dicotyledonous weeds or unwanted crop plants), including, for example, those which are resistant to certain active herbicidal compounds, such as glyphosate, atrazine, glufosinate or imidazolinone herbicides.

Monocotyledonous weeds come, for example, from the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Apera. Dicotyledonous weeds come, for example, from the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia.

The invention also provides for the use of the herbicidal compositions according to the invention for controlling unwanted vegetation, preferably in plant crops.

The herbicidal compositions according to the invention can be produced by known processes, for example as mixed formulations of the individual components, optionally with further active ingredients, additives and/or customary formulation auxiliaries, and these are then applied in a customary manner diluted with water, or as tankmixes by joint dilution of the separately formulated or partly separately formulated individual components with water. Likewise possible is application at different times (split application) of the separately formulated or partly separately formulated individual components. It is also possible to apply the individual components or the herbicidal compositions in a plurality of portions (sequential application), for example by pre-emergence applications followed by post-emergence applications or by early post-emergence applications followed by medium or late post-emergence applications. Preference is given to the joint or immediately successive application of the active ingredients in the respective combination.

The herbicidal compositions according to the invention can also be used for control of harmful plants in crops of genetically modified plants which are known or are yet to be developed.

In general, the transgenic plants are characterised by particular advantageous properties, for example by resistances to certain pesticides, in particular certain herbicides, resistances to plant diseases or pathogens of plant diseases, such as certain insects or microorganisms such as fungi, bacteria or viruses. Other particular properties relate, for example, to the harvested material with regard to quantity, quality, storability, composition and specific constituents. For instance, there are known transgenic plants with an elevated starch content or altered starch quality, or those with a different fatty acid composition in the harvested material. Other particular properties may be tolerance or resistance to abiotic stressors, for example heat, low temperatures, drought, salinity and ultraviolet radiation.

Preference is given to the use of the herbicidal compositions according to the invention in economically important transgenic crops of useful plants and ornamentals, for example of cereals such as wheat, barley, rye, oats, millet/sorghum, rice, cassava and corn, or else crops of sugar beet, cotton, soybean, oilseed rape, potato, tomato, peas and other vegetables.

Conventional ways of producing novel plants which have modified properties in comparison to existing plants consist, for example, in traditional cultivation methods and the generation of mutants. Alternatively, novel plants with modified properties can be generated with the aid of recombinant methods (see, for example, EP-A-0221044, EP-A-0131624). For example, there have been descriptions in several cases of:
genetic modifications of crop plants for the purpose of modifying the starch synthesized in the plants (for example WO 92/11376, WO 92/14827, WO 91/19806),
transgenic crop plants which are resistant to particular herbicides of the glufosinate type (cf., for example, EP-A-0242236, EP-A-242246) or glyphosate type (WO 92/00377) or of the sulfonylurea type (EP-A-0257993, U.S. Pat. No. 5,013,659),
transgenic crop plants, for example cotton, with the ability to produce Bacillus thuringiensis toxins (Bt toxins), which make the
   plants resistant to particular pests (EP-A-0142924, EP-A-0193259),
transgenic crop plants having a modified fatty acid composition (WO 91/13972),
genetically modified crop plants with novel constituents or secondary metabolites, for example novel phytoalexins, which bring about an increased disease resistance (EPA 309862, EPA0464461),
genetically modified plants having reduced photorespiration, which have higher yields and higher stress tolerance (EPA 0305398),
transgenic crop plants which produce pharmaceutically or diagnostically important proteins (“molecular pharming”),
transgenic crop plants which feature higher yields or better quality,
transgenic crop plants which feature a combination, for example, of the abovementioned novel properties (“gene stacking”).

Numerous molecular biology techniques which can be used to produce novel transgenic plants with modified properties are known in principle; see, for example, I. Potrykus and G. Spangenberg (eds.) Gene Transfer to Plants, Springer Lab Manual (1995), Springer Verlag Berlin, Heidelberg, or Christou, “Trends in Plant Science” 1 (1996) 423-431.

For such genetic manipulations, nucleic acid molecules which allow mutagenesis or sequence alteration by recombination of DNA sequences can be introduced into plasmids. With the aid of standard methods, it is possible, for example, to undertake base exchanges, remove parts of sequences or add natural or synthetic sequences. For the connection of the DNA fragments to one another, it is possible to add adapters or linkers to the fragments; see, for example, Sambrook et al., 1989, Molecular Cloning, A Laboratory Manual, 2nd ed., Cold Spring Harbor Laboratory Press, Cold Spring Harbor, NY; or Winnacker “Gene und Klone” [Genes and Clones], VCH Weinheim, 2nd edition, 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical to them.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants.

Obtainable in this way are transgenic plants having properties altered by overexpression, suppression or inhibition of homologous (=natural) genes or gene sequences or expression of heterologous (=foreign) genes or gene sequences.

Preferably the compositions according to the invention can be used in transgenic crops which are resistant to growth regulators such as, for example, dicamba, or to herbicides which inhibit essential plant enzymes, for example acetolactate synthases (ALS), EPSP synthases, glutamine synthases (GS) or hydroxyphenylpyruvate dioxygenases (HPPD), or to herbicides from the group of the sulfonylureas, the glyphosates, glufosinates or benzoylisoxazoles and analogous active ingredients.

When the compositions according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the compositions according to the invention for control of harmful plants in transgenic crop plants.

Preference is given to the use of the compositions according to the invention in economically important transgenic crops of useful plants and ornamentals, for example of cereals (e.g. wheat, barley, rye, oats), millet/sorghum, rice, cassava and corn, or else crops of sugar beet, cotton, soybean, oilseed rape, potato, tomato, peas and other vegetable crops.

The invention therefore also provides for the use of the compositions according to the invention for control of harmful plants in transgenic crop plants or crop plants having tolerance through selective breeding.

The herbicides (A), (B) and any safeners (C) can be converted together or separately to customary formulations, for example for application by spraying, watering, sprinkling and seed dressing, such as solutions, emulsions, suspensions, powders, foams, pastes, granules, aerosols, active ingredient-impregnated natural and synthetic substances, microencapsulations in polymeric substances. The formulations may comprise the customary auxiliaries and additives.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers.

When the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and the ethers and esters thereof, ketones such as acetone, methyl ethyl ketone, methyl isobutyl ketone or cyclohexanone, strongly polar solvents such as dimethylformamide or dimethyl sulfoxide, and water.

Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; useful solid carriers for granules include: for example crushed and fractionated natural rocks, such as calcite, marble, pumice, sepiolite, dolomite and synthetic granules of inorganic and organic flours, and granules of organic material, such as sawdust, coconut shells, corn cobs and tobacco stalks; useful emulsifiers and/or foam formers include: for example nonionic and anionic emulsifiers, such as polyoxyethylene fatty acid esters, polyoxyethylene fatty alcohol ethers, e.g. alkylaryl polyglycol ethers, alkylsulfonates, alkylsulfates, arylsulfonates and protein hydrolysates; useful dispersants include: for example lignosulfite waste liquors and methylcellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Further additives may be mineral and vegetable oils.

It is possible to use colorants such as inorganic pigments, for example iron oxide, titanium oxide and Prussian blue, and organic colorants such as alizarin colorants, azocolorants and metal phthalocyanine colorants, and trace nutrients such as salts of iron, manganese, boron, copper, cobalt, molybdenum and zinc.

The formulations generally comprise between 0.1 and 95 percent by weight of active compound, preferably between 0.5 and 90% by weight.

As such or in their formulations, the herbicides (A), (B) and any safeners (C) can also be used as a mixture with other active agrochemical ingredients for controlling unwanted vegetation, for example for controlling weeds or for controlling unwanted crop plants, finished formulations or tank mixes, for example, being possible.

Also possible are mixtures with other known active ingredients such as fungicides, insecticides, acaricides, nematicides, bird antifeedants, plant nutrients and soil improvers, and likewise with additives and formulation auxiliaries customary in crop protection.

The herbicides (A), (B) and any safeners (C) can be used as such, in the form of their formulations or the use forms prepared therefrom by further dilution, such as ready-to-use solutions, suspensions, emulsions, powders, pastes and granules. Application is typically accomplished, for example, by watering, sprinkling, spraying, broadcasting.

The active compounds can be deployed on the plants, plant parts, seed or area under cultivation (farmland), preferably on the seed or the green plants and plant parts, and optionally additionally to the farmland. One possible use is the joint application of the active ingredients in the form of tankmixes, where the optimally formulated concentrated formulations of the individual active ingredients together are mixed in a tank with water, and the spray liquor obtained is deployed.

A joint formulation of the combination according to the invention of herbicides (A), (B) and optionally (C) has the advantage that it is easier to apply because the amounts of the components are already in an optimal ratio. Moreover, the auxiliaries in the formulation can be optimized to one another.

For application, the formulations in the commercial form are diluted if appropriate in a customary manner, for example with water in the case of wettable powders, emulsifiable concentrates, dispersions and water-dispersible granules. Preparations in dust form, granules for soil application or granules for scattering and sprayable solutions are not normally diluted further with other inert substances prior to application.

### BIOLOGICAL EXAMPLES

The abbreviations used for the harmful plants mean:

| | | | |
|---|---|---|---|
| ABUTH: | Abutilon theophrasti | BRAPP: | Brachiaria platyphylla |
| CYPIR: | Cyperus iria | EMEAU: | Emex australis |
| EPHHL: | Euphorbia | ERIBO: | Erigeron bonariensis |
| | heterophylla | | |
| PHBPU: | Pharbitis purpurea | POLCO: | Polygonum convolvulus |
| SETVI: | Setaria viridis | SOLNI: | Solanum nigrum |
| SORHA: | Sorghum halepense | XANST: | Xanthium strumarium |

### Post-Emergence Herbicidal Action Against Harmful Plants

Seeds of monocotyledonous and dicotyledonous weed and crop plants are laid out in sandy loam soil in wood-fibre pots, covered with soil and cultivated in a greenhouse under good growth conditions. 2 to 3 weeks after sowing, the test plants are treated at the one-leaf stage. The compounds of the invention, formulated in the form of wettable powders (WP) or as emulsion concentrates (EC), are then sprayed onto the green parts of the plants in the form of an aqueous suspension or emulsion at a water application rate equivalent to 600 to 800 l/ha, with addition of 0.2% wetting agent. After the test plants have been left to stand in the greenhouse under optimal growth conditions for about 3 weeks, the action of the preparations is assessed visually in comparison to untreated controls (herbicidal action in percent (%): 100% activity=the plants have died, 0% activity=like control plants). Numerous compounds of the invention showed very good action against a multitude of important harmful plants. The tables below illustrate, in an illustrative manner, the post-emergence herbicidal action of the compounds of the invention, the herbicidal activity being stated in percent.

In the tables that follow, the abbreviations mean the following:
E: means the synergism value to be expected according to the Colby formula.
Δ SYN: means the difference between the actual and expected synergism value.
DAT: means days after treatment.

I-5 means the chiral (S-configured) compound of the formula:

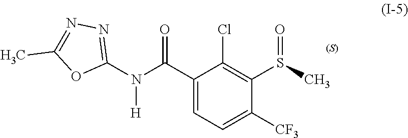

P1: means methyl (2R*,4R*)-4-[[(5S)-3-(3,5-difluorophenyl)-5-vinyl-4H-isoxazole-5-carbonyl]amino]tetrahydrofuran-2-carboxylate.
P2: means methyl (1S,4R)-4-[[(5S)-3-(3,5-difluorophenyl)-5-vinyl-4H-isoxazole-5-carbonyl]amino]cyclopent-2-ene-1-carboxylate.
P3: means 4-amino-3-chloro-5-fluoro-6-(7-fluoro-1H-indol-6-yl)pyridine-2-carboxylic acid.
P4: means ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate.

| | Application rate | Herbicidal efficacy [%] against |
|---|---|---|
| Active ingredient | g a.i./ha | ABUTH 10 DAT |
| I-5 | 2 | 60 |
| | 0.5 | 20 |
| benquitrione | 1.5 | 20 |
| | 6 | 40 |
| I-5 + benquitrione | 2 + 1.5 | 80 (E = 68) Δ = 12 |
| | 0.5 + 6 | 70 (E = 52) Δ = 18 |
| | 0.5 + 1.5 | 75 (E = 36) Δ = 39 |

| | Application rate | Herbicidal efficacy [%] against |
|---|---|---|
| Active ingredient | g a.i./ha | ABUTH 21 DAT |
| I-5 | 0.5 | 10 |
| benquitrione | 6 | 10 |
| I-5 + benquitrione | 0.5 + 6 | 30 (E = 19) Δ = 11 |

| | Application rate | Herbicidal efficacy [%] against |
|---|---|---|
| Active ingredient | g a.i./ha | ABUTH 21 DAT |
| I-5 | 0.5 | 10 |
| dioxopyritrione | 10 | 80 |
| I-5 + | 0.5 + 10 | 88 (E = 82) Δ = 6 |
| dioxopyritrione | | |

| | Application rate | Herbicidal efficacy [%] against |
|---|---|---|
| Active ingredient | g a.i./ha | ABUTH 21 DAT |
| I-5 | 0.5 | 10 |
| fenpyrazone | 20 | 30 |
| I-5 + fenpyrazone | 0.5 + 20 | 50 (E = 37) Δ = 13 |

| | Application rate | Herbicidal efficacy [%] against |
|---|---|---|
| Active ingredient | g a.i./ha | ABUTH 21 DAT |
| I-5 | 0.5 | 10 |
| florpyrauxifen | 0.3 | 90 |
| I-5 + florpyrauxifen | 0.5 + 0.3 | 97 (E = 91) Δ = 6 |

| | Application rate | Herbicidal efficacy [%] against |
|---|---|---|
| Active ingredient | g a.i./ha | ABUTH 10 DAT |
| I-5 | 0.5 | 20 |
| P1 | 0.3 | 70 |
| I-5 + P1 | 0.5 + 0.3 | 88 (E = 76) Δ = 12 |

| | Application rate | Herbicidal efficacy [%] against |
|---|---|---|
| Active ingredient | g a.i./ha | ABUTH 21 DAT |
| I-5 | 2 | 30 |
| P1 | 1.2 | 85 |
| I-5 + P1 | 2 + 1.2 | 95 (E = 89.5) Δ = 5.5 |

| | Application rate | Herbicidal efficacy [%] against |
|---|---|---|
| Active ingredient | g a.i./ha | ABUTH 10 DAT |
| I-5 | 2 | 60 |
| | 0.5 | 20 |
| P2 | 1.2 | 30 |
| | 0.3 | 20 |
| I-5 + P2 | 2 + 1.2 | 90 (E = 72) Δ = 18 |
| | 2 + 0.3 | 88 (E = 68) Δ = 20 |
| | 0.5 + 1.2 | 88 (E = 44) Δ = 44 |
| | 0.5 + 0.3 | 88 (E = 36) Δ = 52 |

| | Application rate | Herbicidal efficacy [%] against |
|---|---|---|
| Active ingredient | g a.i./ha | ABUTH 21 DAT |
| I-5 | 2 | 30 |
| | 0.5 | 10 |
| P2 | 1.2 | 20 |
| | 0.3 | 10 |
| I-5 + P2 | 2 + 1.2 | 80 (E = 44) Δ = 36 |
| | 2 + 0.3 | 60 (E = 37) Δ = 23 |
| | 0.5 + 1.2 | 70 (E = 28) Δ = 42 |
| | 0.5 + 0.3 | 40 (E = 19) Δ = 21 |

| | Application rate | Herbicidal efficacy [%] against |
|---|---|---|
| Active ingredient | g a.i./ha | ABUTH 21 DAT |
| I-5 | 2 | 30 |
| | 0.5 | 10 |
| P3 | 1.2 | 60 |
| | 0.3 | 60 |
| I-5 + P3 | 2 + 1.2 | 80 (E = 72) Δ = 8 |
| | 2 + 0.3 | 85 (E = 72) Δ = 13 |
| | 0.5 + 1.2 | 80 (E = 64) Δ = 16 |

| | Application rate | Herbicidal efficacy [%] against |
|---|---|---|
| Active ingredient | g a.i./ha | ABUTH 10 DAT |
| I-5 | 0.5 | 20 |
| rimisoxafen | 20 | 88 |
| I-5 + rimisoxafen | 0.5 + 20 | 95 (E = 90.4) Δ = 4.6 |

| | Application rate | Herbicidal efficacy [%] against |
|---|---|---|
| Active ingredient | g a.i./ha | ABUTH 21 DAT |
| I-5 | 2 | 30 |
| | 0.5 | 10 |
| rimisoxafen | 20 | 40 |
| I-5 + rimisoxafen | 2 + 20 | 85 (E = 58) Δ = 27 |
| | 0.5 + 20 | 80 (E = 46) Δ = 34 |

| | Application rate | Herbicidal efficacy [%] against |
|---|---|---|
| Active ingredient | g a.i./ha | ABUTH 10 DAT |
| I-5 | 2 | 60 |
| | 0.5 | 20 |
| tetflupyrolimet | 400 | 0 |
| I-5 + tetflupyrolimet | 2 + 400 | 85 (E = 60) Δ = 25 |
| | 0.5 + 400 | 70 (E = 20) Δ = 50 |

| | Application rate | Herbicidal efficacy [%] against |
|---|---|---|
| Active ingredient | g a.i./ha | ABUTH 21 DAT |
| I-5 | 0.5 | 10 |
| tetflupyrolimet | 400 | 0 |
| I-5 + tetflupyrolimet | 0.5 + 400 | 20 (E = 10) Δ = 10 |

| | Application rate | Herbicidal efficacy [%] against |
|---|---|---|
| Active ingredient | g a.i./ha | ABUTH 10 DAT |
| I-5 | 2 | 60 |
| | 0.5 | 20 |
| trifludimoxazin | 1 | 85 |
| | 0.25 | 88 |
| I-5 + | 2 + 1 | 100 (E = 94) Δ = 6 |
| trifludimoxazin | 0.5 + 1 | 100 (E = 88) Δ = 12 |
| | 0.5 + 0.25 | 98 (E = 90.4) Δ = 7.6 |

| | Application rate | Herbicidal efficacy [%] against |
|---|---|---|
| Active ingredient | g a.i./ha | ABUTH 21 DAT |
| I-5 | 2 | 30 |
| | 0.5 | 10 |
| trifludimoxazin | 1 | 75 |
| | 0.25 | 80 |
| I-5 + | 2 + 1 | 100 (E = 82.5) Δ = 17.5 |
| trifludimoxazin | 2 + 0.25 | 100 (E = 86) Δ = 14 |
| | 0.5 + 1 | 100 (E = 77.5) Δ = 22.5 |
| | 0.5 + 0.25 | 97 (E = 82) Δ = 15 |

| | Application rate | Herbicidal efficacy [%] against |
|---|---|---|
| Active ingredient | g a.i./ha | BRAPP 10 DAT |
| I-5 | 2 | 30 |
| | 0.5 | 0 |
| benquitrione | 1.5 | 20 |
| | 6 | 80 |
| I-5 + benquitrione | 2 + 1.5 | 88 (E = 44) Δ = 44 |
| | 0.5 + 6 | 90 (E = 80) Δ = 10 |
| | 0.5 + 1.5 | 60 (E = 20) Δ = 40 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| benquitrione | 6 | 20 |
| | 1.5 | 10 |
| I-5 + benquitrione | 2 + 6 | 30 (E = 20) Δ = 10 |
| | 2 + 1.5 | 30 (E = 10) Δ = 20 |
| | 0.5 + 6 | 40 (E = 20) Δ = 20 |

| | Application rate | Herbicidal efficacy [%] against |
|---|---|---|
| Active ingredient | g a.i./ha | BRAPP 10 DAT |
| I-5 | 2 | 30 |
| | 0.5 | 0 |
| dioxopyritrione | 10 | 70 |
| | 2.5 | 40 |
| I-5 + | 2 + 10 | 95 (E = 79) Δ = 16 |
| dioxopyritrione | 2 + 2.5 | 90 (E = 58) Δ = 32 |
| | 0.5 + 10 | 95 (E = 70) Δ = 25 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| dioxopyritrione | 10 | 30 |
| | 2.5 | 20 |
| I-5 + | 2 + 10 | 60 (E = 30) Δ = 30 |
| dioxopyritrione | 2 + 2.5 | 50 (E = 20) Δ = 30 |
| | 0.5 + 10 | 60 (E = 30) Δ = 30 |

| | Application rate | Herbicidal efficacy [%] against |
|---|---|---|
| Active ingredient | g a.i./ha | BRAPP 10 DAT |
| I-5 | 2 | 30 |
| | 0.5 | 0 |
| fenpyrazone | 20 | 75 |
| | 5 | 30 |
| I-5 + fenpyrazone | 2 + 20 | 90 (E = 82.5) Δ = 7.5 |
| | 2 + 5 | 88 (E = 51) Δ = 37 |
| | 0.5 + 20 | 88 (E = 75) Δ = 13 |
| | 0.5 + 5 | 60 (E = 30) Δ = 30 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| fenpyrazone | 20 | 20 |
| | 5 | 10 |
| I-5 + fenpyrazone | 2 + 20 | 80 (E = 20) Δ = 60 |
| | 2 + 5 | 75 (E = 10) Δ = 65 |
| | 0.5 + 20 | 30 (E = 20) Δ = 10 |
| | 0.5 + 5 | 20 (E = 10) Δ = 10 |

| | Application rate | Herbicidal efficacy [%] against |
|---|---|---|
| Active ingredient | g a.i./ha | BRAPP 10 DAT |
| I-5 | 2 | 30 |
| florpyrauxifen | 0.3 | 75 |
| I-5 + florpyrauxifen | 2 + 0.3 | 88 (E = 82.5) Δ = 5.5 |

| | Application rate | Herbicidal efficacy [%] against |
|---|---|---|
| Active ingredient | g a.i./ha | BRAPP 21 DAT |
| I-5 | 2 | 0 |
| florpyrauxifen | 0.3 | 60 |
| I-5 + florpyrauxifen | 2 + 0.3 | 70 (E = 60) Δ = 10 |

| | Application rate | Herbicidal efficacy [%] against |
|---|---|---|
| Active ingredient | g a.i./ha | BRAPP 21 DAT |
| I-5 | 2 | 0 |
| P2 | 0.3 | 85 |
| I-5 + P2 | 2 + 0.3 | 90 (E = 85) Δ = 5 |

| | Application rate | Herbicidal efficacy [%] against |
|---|---|---|
| Active ingredient | g a.i./ha | BRAPP 10 DAT |
| I-5 | 2 | 30 |
| P3 | 0.3 | 70 |
| I-5 + P3 | 2 + 0.3 | 88 (E = 79) Δ = 9 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| P3 | 1.2 | 75 |
| | 0.3 | 60 |
| I-5 + P3 | 2 + 1.2 | 88 (E = 75) Δ = 13 |
| | 2 + 0.3 | 85 (E = 60) Δ = 25 |
| | 0.5 + 1.2 | 80 (E = 75) Δ = 5 |

| | Application rate | Herbicidal efficacy [%] against |
|---|---|---|
| Active ingredient | g a.i./ha | BRAPP 10 DAT |
| I-5 | 2 | 30 |
| rimisoxafen | 20 | 30 |
| I-5 + rimisoxafen | 2 + 20 | 95 (E = 51) Δ = 44 |

| | Application rate | Herbicidal efficacy [%] against |
|---|---|---|
| Active ingredient | g a.i./ha | BRAPP 21 DAT |
| I-5 | 2 | 0 |
| rimisoxafen | 20 | 20 |
| I-5 + rimisoxafen | 2 + 20 | 70 (E = 20) Δ = 50 |

| | Application rate | Herbicidal efficacy [%] against |
|---|---|---|
| Active ingredient | g a.i./ha | BRAPP 21 DAT |
| I-5 | 0.5 | 0 |
| tetflupyrolimet | 400 | 70 |
| I-5 + tetflupyrolimet | 0.5 + 400 | 80 (E = 70) Δ = 10 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| tiafenacil | 1 | 40 |
| I-5 + tiafenacil | 2 + 1 | 80 (E = 40) Δ = 40 |
| | 0.5 + 1 | 50 (E = 40) Δ = 10 |

| | Application rate | Herbicidal efficacy [%] against |
|---|---|---|
| Active ingredient | g a.i./ha | BRAPP 10 DAT |
| I-5 | 2 | 30 |
| | 0.5 | 0 |
| tolpyralate | 0.5 | 30 |
| I-5 + tolpyralate | 2 + 0.5 | 90 (E = 51) Δ = 39 |
| | 0.5 + 0.5 | 88 (E = 30) Δ = 58 |

| | Application rate | Herbicidal efficacy [%] against |
|---|---|---|
| Active ingredient | g a.i./ha | BRAPP 21 DAT |
| I-5 | 2 | 0 |
| | 0.5 | 0 |
| tolpyralate | 2 | 80 |
| | 0.5 | 20 |
| I-5 + tolpyralate | 2 + 2 | 85 (E = 80) Δ = 5 |
| | 2 + 0.5 | 85 (E = 20) Δ = 65 |
| | 0.5 + 2 | 85 (E = 80) Δ = 5 |
| | 0.5 + 0.5 | 40 (E = 20) Δ = 20 |

| | Application rate | Herbicidal efficacy [%] against |
|---|---|---|
| Active ingredient | g a.i./ha | BRAPP 10 DAT |
| I-5 | 0.5 | 0 |
| trifludimoxazin | 1 | 80 |
| I-5 + | 0.5 + 1 | 85 (E = 80) Δ = 5 |
| trifludimoxazin | | |

| | Application rate | Herbicidal efficacy [%] against |
|---|---|---|
| Active ingredient | g a.i./ha | CYPIR 10 DAT |
| I-5 | 0.5 | 50 |
| benquitrione | 1.5 | 40 |
| I-5 + benquitrione | 0.5 + 1.5 | 80 (E = 70) Δ = 10 |

| | Application rate | Herbicidal efficacy [%] against |
|---|---|---|
| Active ingredient | g a.i./ha | CYPIR 21 DAT |
| I-5 | 0.5 | 40 |
| benquitrione | 1.5 | 30 |
| I-5 + benquitrione | 0.5 + 1.5 | 70 (E = 58) Δ = 12 |

| | Application rate | Herbicidal efficacy [%] against |
|---|---|---|
| Active ingredient | g a.i./ha | CYPIR 10 DAT |
| I-5 | 2 | 80 |
| | 0.5 | 50 |
| fenpyrazone | 20 | 20 |
| | 5 | 30 |
| I-5 + fenpyrazone | 2 + 20 | 95 (E = 84) Δ = 11 |
| | 0.5 + 20 | 95 (E = 60) Δ = 35 |
| | 0.5 + 5 | 90 (E = 65) Δ = 25 |

| | Application rate | Herbicidal efficacy [%] against |
|---|---|---|
| Active ingredient | g a.i./ha | CYPIR 21 DAT |
| I-5 | 2 | 60 |
| | 0.5 | 40 |
| fenpyrazone | 20 | 10 |
| | 5 | 30 |
| I-5 + fenpyrazone | 2 + 20 | 85 (E = 64) Δ = 21 |
| | 2 + 5 | 80 (E = 72) Δ = 8 |
| | 0.5 + 20 | 85 (E = 46) Δ = 39 |

| | Application rate | Herbicidal efficacy [%] against |
|---|---|---|
| Active ingredient | g a.i./ha | CYPIR 10 DAT |
| I-5 | 2 | 80 |
| | 0.5 | 50 |
| P2 | 0.3 | 50 |
| | 1.2 | 88 |
| I-5 + P2 | 2 + 0.3 | 95 (E = 90) Δ = 5 |
| | 0.5 + 1.2 | 99 (E = 94) Δ = 5 |

| | Application rate | Herbicidal efficacy [%] against |
|---|---|---|
| Active ingredient | g a.i./ha | CYPIR 21 DAT |
| I-5 | 2 | 60 |
| P2 | 1.2 | 88 |
| | 0.3 | 40 |
| I-5 + P2 | 2 + 1.2 | 100 (E = 95.2) Δ = 4.8 |
| | 2 + 0.3 | 88 (E = 76) Δ = 12 |

| | Application rate | Herbicidal efficacy [%] against |
|---|---|---|
| Active ingredient | g a.i./ha | CYPIR 21 DAT |
| I-5 | 2 | 60 |
| | 0.5 | 40 |
| rimisoxafen | 20 | 88 |
| I-5 + rimisoxafen | 2 + 20 | 100 (E = 95.2) Δ = 4.8 |
| | 0.5 + 20 | 100 (E = 92.8) Δ = 7.2 |

| | Application rate | Herbicidal efficacy [%] against |
|---|---|---|
| Active ingredient | g a.i./ha | CYPIR 10 DAT |
| I-5 | 2 | 80 |
| tetflupyrolimet | 400 | 0 |
| I-5 + tetflupyrolimet | 2 + 400 | 90 (E = 80) Δ = 10 |

| | Application rate | Herbicidal efficacy [%] against |
|---|---|---|
| Active ingredient | g a.i./ha | CYPIR 21 DAT |
| I-5 | 2 | 60 |
| tetflupyrolimet | 400 | 0 |
| I-5 + tetflupyrolimet | 2 + 400 | 80 (E = 60) Δ = 20 |

| | Application rate | Herbicidal efficacy [%] against |
|---|---|---|
| Active ingredient | g a.i./ha | CYPIR 21 DAT |
| I-5 | 2 | 60 |
| tiafenacil | 0.25 | 88 |
| I-5 + tiafenacil | 2 + 0.25 | 100 (E = 95.2) Δ = 4.8 |

| | Application rate | Herbicidal efficacy [%] against |
|---|---|---|
| Active ingredient | g a.i./ha | CYPIR 10 DAT |
| I-5 | 2 | 80 |
| | 0.5 | 50 |
| tolpyralate | 0.5 | 40 |
| I-5 + tolpyralate | 2 + 0.5 | 95 (E = 88) Δ = 7 |
| | 0.5 + 0.5 | 90 (E = 70) Δ = 20 |

| | Application rate | Herbicidal efficacy [%] against |
|---|---|---|
| Active ingredient | g a.i./ha | CYPIR 21 DAT |
| I-5 | 2 | 60 |
| | 0.5 | 40 |
| tolpyralate | 2 | 30 |
| | 0.5 | 20 |
| I-5 + tolpyralate | 2 + 2 | 85 (E = 72) Δ = 13 |
| | 2 + 0.5 | 97 (E = 68) Δ = 29 |
| | 0.5 + 2 | 85 (E = 58) Δ = 27 |
| | 0.5 + 0.5 | 75 (E = 52) Δ = 23 |

| | Application rate | Herbicidal efficacy [%] against |
|---|---|---|
| Active ingredient | g a.i./ha | EMEAU 21 DAT |
| I-5 | 0.5 | 0 |
| fenpyrazone | 20 | 0 |
| I-5 + fenpyrazone | 0.5 + 20 | 10 (E = 0) Δ = 10 |

| | Application rate | Herbicidal efficacy [%] against |
|---|---|---|
| Active ingredient | g a.i./ha | EMEAU 21 DAT |
| I-5 | 2 | 10 |
| florpyrauxifen | 1.2 | 75 |
| I-5 + florpyrauxifen | 2 + 1.2 | 90 (E = 77.5) Δ = 12.5 |

| | Application rate | Herbicidal efficacy [%] against |
|---|---|---|
| Active ingredient | g a.i./ha | EMEAU 10 DAT |
| I-5 | 2 | 20 |
| | 0.5 | 20 |
| P1 | 1.2 | 70 |
| I-5 + P1 | 2 + 1.2 | 90 (E = 76) Δ = 14 |
| | 0.5 + 1.2 | 85 (E = 76) Δ = 9 |

| | Application rate | Herbicidal efficacy [%] against |
|---|---|---|
| Active ingredient | g a.i./ha | EMEAU 21 DAT |
| I-5 | 2 | 10 |
| | 0.5 | 0 |
| P1 | 1.2 | 80 |
| I-5 + P1 | 2 + 1.2 | 95 (E = 82) Δ = 13 |
| | 0.5 + 1.2 | 88 (E = 80) Δ = 8 |

| | Application rate | Herbicidal efficacy [%] against |
|---|---|---|
| Active ingredient | g a.i./ha | EMEAU 21 DAT |
| I-5 | 2 | 10 |
| P2 | 1.2 | 88 |
| | 0.3 | 88 |
| I-5 + P2 | 2 + 1.2 | 95 (E = 89.2) Δ = 5.8 |
| | 2 + 0.3 | 99 (E = 89.2) Δ = 9.8 |

| | Application rate | Herbicidal efficacy [%] against |
|---|---|---|
| Active ingredient | g a.i./ha | EMEAU 21 DAT |
| I-5 | 2 | 10 |
| | 0.5 | 0 |
| P3 | 1.2 | 70 |
| I-5 + P3 | 2 + 1.2 | 90 (E = 73) Δ = 17 |
| | 0.5 + 1.2 | 100 (E = 70) Δ = 30 |

| | Application rate | Herbicidal efficacy [%] against |
|---|---|---|
| Active ingredient | g a.i./ha | EMEAU 21 DAT |
| I-5 | 2 | 10 |
| | 0.5 | 0 |
| P4 | 1 | 70 |
| I-5 + P4 | 2 + 1 | 85 (E = 73) Δ = 12 |
| | 0.5 + 1 | 85 (E = 70) Δ = 15 |

| | Application rate | Herbicidal efficacy [%] against |
|---|---|---|
| Active ingredient | g a.i./ha | EMEAU 10 DAT |
| I-5 | 2 | 20 |
| rimisoxafen | 80 | 88 |
| I-5 + rimisoxafen | 2 + 80 | 95 (E = 90.4) Δ = 4.6 |

| | Application rate | Herbicidal efficacy [%] against |
|---|---|---|
| Active ingredient | g a.i./ha | EMEAU 21 DAT |
| I-5 | 2 | 10 |
| rimisoxafen | 80 | 80 |
| I-5 + rimisoxafen | 2 + 80 | 100 (E = 82) Δ = 18 |

| | Application rate | Herbicidal efficacy [%] against |
|---|---|---|
| Active ingredient | g a.i./ha | EMEAU 21 DAT |
| I-5 | 2 | 10 |
| trifludimoxazin | 1 | 85 |
| I-5 + | 2 + 1 | 100 (E = 86.5) Δ = 13.5 |
| trifludimoxazin | | |

| | Application rate | Herbicidal efficacy [%] against |
|---|---|---|
| Active ingredient | g a.i./ha | EPHHL 21 DAT |
| I-5 | 2 | 10 |
| P4 | 1 | 80 |
| I-5 + P4 | 2 + 1 | 88 (E = 82) Δ = 6 |

| | Application rate | Herbicidal efficacy [%] against |
|---|---|---|
| Active ingredient | g a.i./ha | EPHHL 21 DAT |
| I-5 | 0.5 | 0 |
| florpyrauxifen | 0.3 | 90 |
| I-5 + florpyrauxifen | 0.5 + 0.3 | 95 (E = 90) Δ = 5 |

| | Application rate | Herbicidal efficacy [%] against |
|---|---|---|
| Active ingredient | g a.i./ha | EPHHL 21 DAT |
| I-5 | 2 | 10 |
| trifludimoxazin | 0.25 | 88 |
| I-5 + | 2 + 0.25 | 100 (E = 89.2) Δ = 10.8 |
| trifludimoxazin | | |

| | Application rate | Herbicidal efficacy [%] against |
|---|---|---|
| Active ingredient | g a.i./ha | ERIBO 10 DAT |
| I-5 | 0.5 | 0 |
| benquitrione | 6 | 85 |
| I-5 + benquitrione | 0.5 + 6 | 90 (E = 85) Δ = 5 |

| | Application rate | Herbicidal efficacy [%] against |
|---|---|---|
| Active ingredient | g a.i./ha | ERIBO 21 DAT |
| I-5 | 2 | 0 |
| | 0.5 | 0 |
| benquitrione | 6 | 85 |
| I-5 + benquitrione | 2 + 6 | 90 (E = 85) Δ = 5 |
| | 0.5 + 6 | 90 (E = 85) Δ = 5 |

| | Application rate | Herbicidal efficacy [%] against |
|---|---|---|
| Active ingredient | g a.i./ha | ERIBO 10 DAT |
| I-5 | 0.5 | 0 |
| dioxopyritrione | 10 | 90 |
| I-5 + | 0.5 + 10 | 95 (E = 90) Δ = 5 |
| dioxopyritrione | | |

| | Application rate | Herbicidal efficacy [%] against |
|---|---|---|
| Active ingredient | g a.i./ha | ERIBO 21 DAT |
| I-5 | 2 | 0 |
| | 0.5 | 0 |
| dioxopyritrione | 10 | 88 |
| I-5 + | 2 + 10 | 98 (E = 88) Δ = 10 |
| dioxopyritrione | 0.5 + 10 | 99 (E = 88) Δ = 11 |

| | Application rate | Herbicidal efficacy [%] against |
|---|---|---|
| Active ingredient | g a.i./ha | ERIBO 21 DAT |
| I-5 | 2 | 0 |
| | 0.5 | 0 |
| fenpyrazone | 20 | 80 |
| | 5 | 80 |
| I-5 + fenpyrazone | 2 + 20 | 95 (E = 80) Δ = 15 |
| | 2 + 5 | 85 (E = 80) Δ = 5 |
| | 0.5 + 20 | 95 (E = 80) Δ = 15 |

| | Application rate | Herbicidal efficacy [%] against |
|---|---|---|
| Active ingredient | g a.i./ha | ERIBO 10 DAT |
| I-5 | 2 | 10 |
| | 0.5 | 0 |
| P2 | 0.3 | 0 |
| I-5 + P2 | 2 + 0.3 | 30 (E = 10) Δ = 20 |
| | 0.5 + 0.3 | 10 (E = 0) Δ = 10 |

| | Application rate | Herbicidal efficacy [%] against |
|---|---|---|
| Active ingredient | g a.i./ha | ERIBO 21 DAT |
| I-5 | 2 | 0 |
| P2 | 0.3 | 0 |
| I-5 + P2 | 2 + 0.3 | 10 (E = 0) Δ = 10 |

| | Application rate | Herbicidal efficacy [%] against |
|---|---|---|
| Active ingredient | g a.i./ha | ERIBO 21 DAT |
| I-5 | 2 | 0 |
| rimisoxafen | 20 | 10 |
| I-5 + rimisoxafen | 2 + 20 | 20 (E = 10) Δ = 10 |

| | Application rate | Herbicidal efficacy [%] against |
|---|---|---|
| Active ingredient | g a.i./ha | ERIBO 10 DAT |
| I-5 | 0.5 | 0 |
| tolpyralate | 2 | 90 |
| I-5 + tolpyralate | 0.5 + 2 | 95 (E = 90) Δ = 5 |

| | Application rate | Herbicidal efficacy [%] against |
|---|---|---|
| Active ingredient | g a.i./ha | ERIBO 21 DAT |
| I-5 | 2 | 0 |
| | 0.5 | 0 |
| tolpyralate | 2 | 85 |
| I-5 + tolpyralate | 2 + 2 | 99 (E = 85) Δ = 14 |
| | 0.5 + 2 | 96 (E = 85) Δ = 11 |

| | Application rate | Herbicidal efficacy [%] against |
|---|---|---|
| Active ingredient | g a.i./ha | PHBPU 10 DAT |
| I-5 | 2 | 20 |
| | 0.5 | 0 |
| benquitrione | 6 | 40 |
| I-5 + benquitrione | 2 + 6 | 70 (E = 52) Δ = 18 |
| | 0.5 + 6 | 60 (E = 40) Δ = 20 |

| | Application rate | Herbicidal efficacy [%] against |
|---|---|---|
| Active ingredient | g a.i./ha | PHBPU 21 DAT |
| I-5 | 2 | 0 |
| benquitrione | 6 | 20 |
| I-5 + benquitrione | 2 + 6 | 40 (E = 20) Δ = 20 |

| | Application rate | Herbicidal efficacy [%] against |
|---|---|---|
| Active ingredient | g a.i./ha | PHBPU 21 DAT |
| I-5 | 2 | 0 |
| dioxopyritrione | 2.5 | 20 |
| I-5 + | 2 + 2.5 | 30 (E = 20) Δ = 10 |
| dioxopyritrione | | |

| | Application rate | Herbicidal efficacy [%] against |
|---|---|---|
| Active ingredient | g a.i./ha | PHBPU 10 DAT |
| I-5 | 2 | 20 |
| | 0.5 | 0 |
| fenpyrazone | 5 | 0 |
| I-5 + fenpyrazone | 2 + 5 | 30 (E = 20) Δ = 10 |
| | 0.5 + 5 | 20 (E = 0) Δ = 20 |

| | Application rate | Herbicidal efficacy [%] against |
|---|---|---|
| Active ingredient | g a.i./ha | PHBPU 21 DAT |
| I-5 | 2 | 0 |
| | 0.5 | 0 |
| fenpyrazone | 5 | 0 |
| I-5 + fenpyrazone | 2 + 5 | 20 (E = 0) Δ = 20 |
| | 0.5 + 5 | 10 (E = 0) Δ = 10 |

| | Application rate | Herbicidal efficacy [%] against |
|---|---|---|
| Active ingredient | g a.i./ha | PHBPU 10 DAT |
| I-5 | 2 | 20 |
| | 0.5 | 0 |
| rimisoxafen | 20 | 30 |
| I-5 + rimisoxafen | 2 + 20 | 70 (E = 44) Δ = 26 |
| I-5 + rimisoxafen | 0.5 + 20 | 40 (E = 30) Δ = 10 |

| | Application rate | Herbicidal efficacy [%] against |
|---|---|---|
| Active ingredient | g a.i./ha | PHBPU 21 DAT |
| I-5 | 2 | 0 |
| rimisoxafen | 20 | 20 |
| I-5 + rimisoxafen | 2 + 20 | 30 (E = 20) Δ = 10 |

| | Application rate | Herbicidal efficacy [%] against |
|---|---|---|
| Active ingredient | g a.i./ha | PHBPU 10 DAT |
| I-5 | 0.5 | 0 |
| tolpyralate | 0.5 | 10 |
| I-5 + tolpyralate | 0.5 + 0.5 | 20 (E = 10) Δ = 10 |

| | Application rate | Herbicidal efficacy [%] against |
|---|---|---|
| Active ingredient | g a.i./ha | PHBPU 21 DAT |
| I-5 | 2 | 0 |
| tolpyralate | 0.5 | 10 |
| I-5 + tolpyralate | 2 + 0.5 | 20 (E = 10) Δ = 10 |

| | Application rate | Herbicidal efficacy [%] against |
|---|---|---|
| Active ingredient | g a.i./ha | PHBPU 21 DAT |
| I-5 | 2 | 0 |
| | 0.5 | 0 |
| trifludimoxazin | 1 | 80 |
| I-5 + | 2 + 1 | 100 (E = 80) Δ = 20 |
| trifludimoxazin | | |
| I-5 + | 0.5 + 1 | 85 (E = 80) Δ = 5 |
| trifludimoxazin | | |

| | Application rate | Herbicidal efficacy [%] against |
|---|---|---|
| Active ingredient | g a.i./ha | POLCO 10 DAT |
| I-5 | 2 | 0 |
| | 0.5 | 0 |
| benquitrione | 6 | 20 |
| I-5 + benquitrione | 2 + 6 | 30 (E = 20) Δ = 10 |
| I-5 + benquitrione | 0.5 + 6 | 40 (E = 20) Δ = 20 |

| | Application rate | Herbicidal efficacy [%] against |
|---|---|---|
| Active ingredient | g a.i./ha | POLCO 10 DAT |
| I-5 | 2 | 0 |
| | 0.5 | 0 |
| dioxopyritrione | 2.5 | 80 |
| | 10 | 80 |
| I-5 + | 2 + 2.5 | 95 (E = 80) Δ = 15 |
| dioxopyritrione | | |
| I-5 + | 0.5 + 10 | 90 (E = 80) Δ = 10 |
| dioxopyritrione | | |

| | Application rate | Herbicidal efficacy [%] against |
|---|---|---|
| Active ingredient | g a.i./ha | POLCO 21 DAT |
| I-5 | 0.5 | 0 |
| dioxopyritrione | 10 | 70 |
| I-5 + | 0.5 + 10 | 88 (E = 70) Δ = 18 |
| dioxopyritrione | | |

| | Application rate | Herbicidal efficacy [%] against |
|---|---|---|
| Active ingredient | g a.i./ha | POLCO 10 DAT |
| I-5 | 2 | 0 |
| | 0.5 | 0 |
| fenpyrazone | 5 | 0 |
| I-5 + fenpyrazone | 2 + 5 | 30 (E = 0) Δ = 30 |
| I-5 + fenpyrazone | 0.5 + 5 | 20 (E = 0) Δ = 20 |

| | Application rate | Herbicidal efficacy [%] against |
|---|---|---|
| Active ingredient | g a.i./ha | POLCO 21 DAT |
| I-5 | 2 | 0 |
| | 0.5 | 0 |
| fenpyrazone | 20 | 10 |
| | 5 | 0 |
| I-5 + fenpyrazone | 2 + 20 | 30 (E = 10) Δ = 20 |
| | 2 + 5 | 20 (E = 0) Δ = 20 |
| | 0.5 + 5 | 10 (E = 0) Δ = 10 |

| | Application rate | Herbicidal efficacy [%] against |
|---|---|---|
| Active ingredient | g a.i. / ha | POLCO 10 DAT |
| I-5 | 2 | 0 |
| florpyrauxifen | 1.2 | 90 |
| I-5 + florpyrauxifen | 2 + 1.2 | 98 (E = 90) Δ = 8 |

| | Application rate | Herbicidal efficacy [%] against |
|---|---|---|
| Active ingredient | g a.i. / ha | POLCO 21 DAT |
| I-5 | 2 | 0 |
| | 0.5 | 0 |
| florpyrauxifen | 1.2 | 90 |
| I-5 + florpyrauxifen | 2 + 1.2 | 100 (E = 90) Δ = 10 |
| I-5 + florpyrauxifen | 0.5 + 1.2 | 100 (E = 90) Δ = 10 |

| | Application rate | Herbicidal efficacy [%] against |
|---|---|---|
| Active ingredient | g a.i. / ha | POLCO 21 DAT |
| I-5 | 2 | 0 |
| P2 | 0.3 | 90 |
| I-5 + P2 | 2 + 0.3 | 95 (E = 90) Δ = 5 |

| | Application rate | Herbicidal efficacy [%] against |
|---|---|---|
| Active ingredient | g a.i. / ha | POLCO 21 DAT |
| I-5 | 2 | 0 |
| | 0.5 | 0 |
| rimisoxafen | 80 | 88 |
| | 20 | 60 |
| I-5 + rimisoxafen | 2 + 80 | 100 (E = 88) Δ = 12 |
| | 2 + 20 | 80 (E = 60) Δ = 20 |
| | 0.5 + 80 | 99 (E = 88) Δ = 11 |
| | 0.5 + 20 | 88 (E = 60) Δ = 28 |

| | Application rate | Herbicidal efficacy [%] |
|---|---|---|
| Active ingredient | g a.i. / ha | against POLCO 10 DAT |
| I-5 | 2 | 0 |
| tetflupyrolimet | 400 | 10 |
| I-5 + tetflupyrolimet | 2 + 400 | 20 (E = 10) Δ = 10 |

| | Application rate | Herbicidal efficacy [%] |
|---|---|---|
| Active ingredient | g a.i. / ha | against POLCO 21 DAT |
| I-5 | 2 | 0 |
| | 0.5 | 0 |
| tetflupyrolimet | 400 | 0 |
| | 100 | 0 |
| I-5 + tetflupyrolimet | 2 + 400 | 10 (E = 0) Δ = 10 |
| | 0.5 + 400 | 10 (E = 0) Δ = 10 |
| | 0.5 + 100 | 10 (E = 0) Δ = 10 |

| | Application rate | Herbicidal efficacy [%] against |
|---|---|---|
| Active ingredient | g a.i. / ha | POLCO 10 DAT |
| I-5 | 2 | 0 |
| tolpyralate | 0.5 | 30 |
| I-5 + tolpyralate | 2 + 0.5 | 50 (E = 30) Δ = 20 |

| | Application rate | Herbicidal efficacy [%] against |
|---|---|---|
| Active ingredient | g a.i. / ha | POLCO 21 DAT |
| I-5 | 2 | 0 |
| tolpyralate | 0.5 | 20 |
| I-5 + tolpyralate | 2 + 0.5 | 30 (E = 20) Δ = 10 |

| | Application rate | Herbicidal efficacy [%] against |
|---|---|---|
| Active ingredient | g a.i. / ha | SETVI 10 DAT |
| I-5 | 0.5 | 20 |
| benquitrione | 6 | 88 |
| I-5 + benquitrione | 0.5 + 6 | 95 (E = 90.4) Δ = 4.6 |

| | Application rate | Herbicidal efficacy [%] against |
|---|---|---|
| Active ingredient | g a.i. / ha | SETVI 21 DAT |
| I-5 | 2 | 20 |
| | 0.5 | 10 |
| benquitrione | 1.5 | 50 |
| I-5 + benquitrione | 2 + 1.5 | 70 (E = 60) Δ = 10 |
| I-5 + benquitrione | 0.5 + 1.5 | 60 (E = 55) Δ = 5 |

| | Application rate | Herbicidal efficacy [%] |
|---|---|---|
| Active ingredient | g a.i. / ha | against SETVI 10 DAT |
| I-5 | 2 | 40 |
| | 0.5 | 20 |
| dioxopyritrione | 10 | 20 |
| | 2.5 | 10 |
| I-5 + dioxopyritrione | 2 + 10 | 90 (E = 52) Δ = 38 |
| | 2 + 2.5 | 60 (E = 46) Δ = 14 |
| | 0.5 + 10 | 50 (E = 36) Δ = 14 |

| | Application rate | Herbicidal efficacy [%] |
|---|---|---|
| Active ingredient | g a.i. / ha | against SETVI 21 DAT |
| I-5 | 2 | 20 |
| dioxopyritrione | 10 | 20 |
| | 2.5 | 10 |
| I-5 + dioxopyritrione | 2 + 10 | 60 (E = 36) Δ = 24 |
| I-5 + dioxopyritrione | 2 + 2.5 | 40 (E = 28) Δ = 12 |

| | Application rate | Herbicidal efficacy [%] against |
|---|---|---|
| Active ingredient | g a.i. / ha | SETVI 10 DAT |
| I-5 | 2 | 40 |
| | 0.5 | 20 |
| fenpyrazone | 20 | 50 |
| | 5 | 30 |
| I-5 + fenpyrazone | 2 + 20 | 85 (E = 70) Δ = 15 |
| | 2 + 5 | 85 (E = 58) Δ = 27 |
| | 0.5 + 20 | 70 (E = 60) Δ = 10 |

| | Application rate | Herbicidal efficacy [%] against |
|---|---|---|
| Active ingredient | g a.i. / ha | SETVI 21 DAT |
| I-5 | 2 | 20 |
| | 0.5 | 10 |
| fenpyrazone | 20 | 20 |
| | 5 | 20 |
| I-5 + fenpyrazone | 2 + 20 | 80 (E = 36) Δ = 44 |
| | 2 + 5 | 60 (E = 36) Δ = 24 |
| | 0.5 + 20 | 60 (E = 28) Δ = 32 |

| | Application rate | Herbicidal efficacy [%] against |
|---|---|---|
| Active ingredient | g a.i. / ha | SETVI 10 DAT |
| I-5 | 2 | 40 |
| | 0.5 | 20 |
| florpyrauxifen | 0.3 | 30 |
| I-5 + florpyrauxifen | 2 + 0.3 | 70 (E = 58) Δ = 12 |
| I-5 + florpyrauxifen | 0.5 + 0.3 | 60 (E = 44) Δ = 16 |

| | Application rate | Herbicidal efficacy [%] against |
|---|---|---|
| Active ingredient | g a.i. / ha | SETVI 21 DAT |
| I-5 | 2 | 20 |
| florpyrauxifen | 0.3 | 40 |
| I-5 + florpyrauxifen | 2 + 0.3 | 80 (E = 52) Δ = 28 |

| | Application rate | Herbicidal efficacy [%] against |
|---|---|---|
| Active ingredient | g a.i. / ha | SETVI 21 DAT |
| I-5 | 2 | 20 |
| P3 | 0.3 | 70 |
| I-5 + P3 | 2 + 0.3 | 85 (E = 76) Δ = 9 |

| | Application rate | Herbicidal efficacy [%] against |
|---|---|---|
| Active ingredient | g a.i. / ha | SETVI 10 DAT |
| I-5 | 2 | 40 |
| | 0.5 | 20 |
| P4 | 1 | 88 |
| I-5 + P4 | 2 + 1 | 100 (E = 92.8) Δ = 7.2 |
| I-5 + P4 | 0.5 + 1 | 99 (E = 90.4) Δ = 8.6 |

| | Application rate | Herbicidal efficacy [%] against |
|---|---|---|
| Active ingredient | g a.i. / ha | SETVI 21 DAT |
| I-5 | 2 | 20 |
| P4 | 1 | 80 |
| I-5 + P4 | 2 + 1 | 100 (E = 84) Δ = 16 |

| | Application rate | Herbicidal efficacy [%] against |
|---|---|---|
| Active ingredient | g a.i. / ha | SETVI 21 DAT |
| I-5 | 2 | 20 |
| | 0.5 | 10 |
| rimisoxafen | 20 | 30 |
| I-5 + rimisoxafen | 2 + 20 | 95 (E = 44) Δ = 51 |
| I-5 + rimisoxafen | 0.5 + 20 | 80 (E = 37) Δ = 43 |

| | Application rate | Herbicidal efficacy [%] against |
|---|---|---|
| Active ingredient | g a.i. / ha | SETVI 21 DAT |
| I-5 | 2 | 20 |
| | 0.5 | 10 |
| tolpyralate | 2 | 88 |
| | 0.5 | 60 |
| I-5 + tolpyralate | 2 + 2 | 95 (E = 90.4) Δ = 4.6 |
| | 2 + 0.5 | 80 (E = 68) Δ = 12 |
| | 0.5 + 2 | 95 (E = 89.2) Δ = 5.8 |

| | Application rate | Herbicidal efficacy [%] |
|---|---|---|
| Active ingredient | g a.i. / ha | against SETVI 10 DAT |
| I-5 | 2 | 40 |
| trifludimoxazin | 0.25 | 85 |
| I-5 + trifludimoxazin | 2 + 0.25 | 99 (E = 91) Δ = 8 |

| | Application rate | Herbicidal efficacy [%] |
|---|---|---|
| Active ingredient | g a.i. / ha | against SETVI 21 DAT |
| I-5 | 2 | 20 |
| trifludimoxazin | 0.25 | 70 |
| I-5 + trifludimoxazin | 2 + 0.25 | 95 (E = 76) Δ = 19 |

| | Application rate | Herbicidal efficacy [%] against |
|---|---|---|
| Active ingredient | g a.i. / ha | SOLNI 21 DAT |
| I-5 | 2 | 20 |
| | 0.5 | 0 |
| benquitrione | 6 | 85 |
| I-5 + benquitrione | 2 + 6 | 97 (E = 88) Δ = 9 |
| I-5 + benquitrione | 0.5 + 6 | 99 (E = 85) Δ = 14 |

| | Application rate | Herbicidal efficacy [%] against |
|---|---|---|
| Active ingredient | g a.i. / ha | SOLNI 10 DAT |
| I-5 | 2 | 60 |
| | 0.5 | 20 |
| P1 | 0.3 | 40 |
| I-5 + P1 | 2 + 0.3 | 85 (E = 76) Δ = 9 |
| I-5 + P1 | 0.5 + 0.3 | 85 (E = 52) Δ = 33 |

| | Application rate | Herbicidal efficacy [%] against |
|---|---|---|
| Active ingredient | g a.i. / ha | SOLNI 10 DAT |
| I-5 | 0.5 | 20 |
| P2 | 0.3 | 60 |
| I-5 + P2 | 0.5 + 0.3 | 80 (E = 68) Δ = 12 |

| | Application rate | Herbicidal efficacy [%] against |
|---|---|---|
| Active ingredient | g a.i. / ha | SOLNI 21 DAT |
| I-5 | 2 | 20 |
| P2 | 1.2 | 40 |
| I-5 + P2 | 2 + 1.2 | 60 (E = 52) Δ = 8 |

| | Application rate | Herbicidal efficacy [%] against |
|---|---|---|
| Active ingredient | g a.i. / ha | SOLNI 21 DAT |
| I-5 | 2 | 20 |
| | 0.5 | 0 |
| P3 | 1.2 | 85 |
| I-5 + P3 | 2 + 1.2 | 99 (E = 88) Δ = 11 |
| I-5 + P3 | 0.5 + 1.2 | 100 (E = 85) Δ = 15 |

| | Application rate | Herbicidal efficacy [%] against |
|---|---|---|
| Active ingredient | g a.i. / ha | SOLNI 10 DAT |
| I-5 | 0.5 | 20 |
| rimisoxafen | 80 | 88 |
| I-5 + rimisoxafen | 0.5 + 80 | 95 (E = 90.4) Δ = 4.6 |

| | Application rate | Herbicidal efficacy [%] against |
|---|---|---|
| Active ingredient | g a.i. / ha | SOLNI 21 DAT |
| I-5 | 0.5 | 0 |
| rimisoxafen | 80 | 80 |
| I-5 + rimisoxafen | 0.5 + 80 | 100 (E = 80) Δ = 20 |

| | Application rate | Herbicidal efficacy [%] |
|---|---|---|
| Active ingredient | g a.i./ha | against SOLNI 10 DAT |
| I-5 | 2 | 60 |
| | 0.5 | 20 |
| tetflupyrolimet | 400 | 10 |
| I-5 + tetflupyrolimet | 2 + 400 | 70 (E = 64) Δ = 6 |
| I-5 + tetflupyrolimet | 0.5 + 400 | 40 (E = 28) Δ = 12 |

| | Application rate | Herbicidal efficacy [%] |
|---|---|---|
| Active ingredient | g a.i./ha | against SOLNI 21 DAT |
| I-5 | 0.5 | 0 |
| tetflupyrolimet | 400 | 0 |
| I-5 + tetflupyrolimet | 0.5 + 400 | 10 (E = 0) Δ = 10 |

| | Application rate | Herbicidal efficacy [%] |
|---|---|---|
| Active ingredient | g a.i./ha | against SOLNI 10 DAT |
| I-5 | 2 | 60 |
| | 0.5 | 20 |
| tiafenacil | 1 | 88 |
| I-5 + tiafenacil | 2 + 1 | 100 (E = 95.2) Δ = 4.8 |
| I-5 + tiafenacil | 0.5 + 1 | 100 (E = 90.4) Δ = 9.6 |

| | Application rate | Herbicidal efficacy [%] |
|---|---|---|
| Active ingredient | g a.i./ha | against SOLNI 21 DAT |
| I-5 | 2 | 20 |
| | 0.5 | 0 |
| tiafenacil | 1 | 60 |
| I-5 + tiafenacil | 2 + 1 | 100 (E = 68) Δ = 32 |
| I-5 + tiafenacil | 0.5 + 1 | 100 (E = 60) Δ = 40 |

| | Application rate | Herbicidal efficacy [%] |
|---|---|---|
| Active ingredient | g a.i./ha | against SOLNI 21 DAT |
| I-5 | 2 | 20 |
| tolpyralate | 0.5 | 85 |
| I-5 + tolpyralate | 2 + 0.5 | 97 (E = 88) Δ = 9 |

| | Application rate | Herbicidal efficacy [%] |
|---|---|---|
| Active ingredient | g a.i./ha | against SOLNI 10 DAT |
| I-5 | 2 | 60 |
| | 0.5 | 20 |
| trifludimoxazin | 1 | 88 |
| I-5 + trifludimoxazin | 2 + 1 | 100 (E = 95.2) Δ = 4.8 |
| I-5 + trifludimoxazin | 0.5 + 1 | 100 (E = 90.4) Δ = 9.6 |

| | Application rate | Herbicidal efficacy [%] |
|---|---|---|
| Active ingredient | g a.i./ha | against SOLNI 21 DAT |
| I-5 | 2 | 20 |
| | 0.5 | 0 |
| trifludimoxazin | 1 | 60 |
| I-5 + trifludimoxazin | 2 + 1 | 99 (E = 68) Δ = 31 |
| I-5 + trifludimoxazin | 0.5 + 1 | 100 (E = 60) Δ = 40 |

| | Application rate | Herbicidal efficacy [%] |
|---|---|---|
| Active ingredient | g a.i./ha | against SORHA 10 DAT |
| I-5 | 0.5 | 0 |
| benquitrione | 6 | 20 |
| | 1.5 | 10 |
| I-5 + benquitrione | 0.5 + 6 | 40 (E = 20) Δ = 20 |
| I-5 + benquitrione | 0.5 + 1.5 | 40 (E = 10) Δ = 30 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| benquitrione | 1.5 | 0 |
| | 6 | 10 |
| I-5 + benquitrione | 2 + 1.5 | 20 (E = 10) Δ = 10 |
| | 0.5 + 6 | 20 (E = 10) Δ = 10 |
| | 0.5 + 1.5 | 10 (E = 0) Δ = 10 |

| | Application rate | Herbicidal efficacy [%] |
|---|---|---|
| Active ingredient | g a.i./ha | against SORHA 10 DAT |
| I-5 | 2 | 20 |
| | 0.5 | 0 |
| dioxopyritrione | 10 | 30 |
| | 2.5 | 20 |
| I-5 + dioxopyritrione | 2 + 10 | 80 (E = 44) Δ = 36 |
| | 0.5 + 10 | 60 (E = 30) Δ = 30 |
| | 0.5 + 2.5 | 30 (E = 20) Δ = 10 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| dioxopyritrione | 10 | 10 |
| | 2.5 | 0 |
| I-5 + dioxopyritrione | 2 + 10 | 40 (E = 19) Δ = 21 |
| | 0.5 + 10 | 30 (E = 10) Δ = 20 |
| | 0.5 + 2.5 | 10 (E = 0) Δ = 10 |

| | Application rate | Herbicidal efficacy [%] |
|---|---|---|
| Active ingredient | g a.i./ha | against SORHA 10 DAT |
| I-5 | 2 | 20 |
| | 0.5 | 0 |
| fenpyrazone | 20 | 30 |
| | 5 | 20 |
| I-5 + fenpyrazone | 2 + 20 | 88 (E = 44) Δ = 44 |
| | 2 + 5 | 70 (E = 36) Δ = 34 |
| | 0.5 + 20 | 85 (E = 30) Δ = 55 |
| | 0.5 + 5 | 60 (E = 20) Δ = 40 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| fenpyrazone | 20 | 20 |
| | 5 | 10 |
| I-5 + fenpyrazone | 2 + 20 | 60 (E = 28) Δ = 32 |
| | 2 + 5 | 40 (E = 19) Δ = 21 |
| | 0.5 + 20 | 30 (E = 20) Δ = 10 |
| | 0.5 + 5 | 40 (E = 10) Δ = 30 |

| | Application rate | Herbicidal efficacy [%] |
|---|---|---|
| Active ingredient | g a.i./ha | against SORHA 10 DAT |
| I-5 | 0.5 | 0 |
| florpyrauxifen | 0.3 | 10 |
| I-5 + florpyrauxifen | 0.5 + 0.3 | 20 (E = 10) Δ = 10 |

| | Application rate | Herbicidal efficacy [%] |
|---|---|---|
| Active ingredient | g a.i./ha | against SORHA 21 DAT |
| I-5 | 0.5 | 0 |
| P1 | 1.2 | 90 |
| | 0.3 | 90 |
| I-5 + P1 | 0.5 + 1.2 | 95 (E = 90) Δ = 5 |
| I-5 + P1 | 0.5 + 0.3 | 95 (E = 90) Δ = 5 |

| | Application rate | Herbicidal efficacy [%] |
|---|---|---|
| Active ingredient | g a.i./ha | against SORHA 10 DAT |
| I-5 | 0.5 | 0 |
| P2 | 0.3 | 80 |
| I-5 + P2 | 0.5 + 0.3 | 85 (E = 80) Δ = 5 |

| | Application rate | Herbicidal efficacy [%] |
|---|---|---|
| Active ingredient | g a.i./ha | against SORHA 10 DAT |
| I-5 | 2 | 20 |
| | 0.5 | 0 |
| P3 | 0.3 | 30 |
| | 1.2 | 60 |
| I-5 + P3 | 2 + 0.3 | 60 (E = 44) Δ = 16 |
| I-5 + P3 | 0.5 + 1.2 | 80 (E = 60) Δ = 20 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| P3 | 0.3 | 10 |
| | 1.2 | 30 |
| I-5 + P3 | 2 + 0.3 | 30 (E = 19) Δ = 11 |
| I-5 + P3 | 0.5 + 1.2 | 60 (E = 30) Δ = 30 |

| | Application rate | Herbicidal efficacy [%] |
|---|---|---|
| Active ingredient | g a.i./ha | against SORHA 10 DAT |
| I-5 | 2 | 20 |
| rimisoxafen | 20 | 10 |
| I-5 + rimisoxafen | 2 + 20 | 95 (E = 28) Δ = 67 |

| | Application rate | Herbicidal efficacy [%] |
|---|---|---|
| Active ingredient | g a.i./ha | against SORHA 21 DAT |
| I-5 | 2 | 10 |
| rimisoxafen | 20 | 10 |
| I-5 + rimisoxafen | 2 + 20 | 70 (E = 19) Δ = 51 |

| | Application rate | Herbicidal efficacy [%] |
|---|---|---|
| Active ingredient | g a.i./ha | against SORHA 10 DAT |
| I-5 | 0.5 | 0 |
| tetflupyrolimet | 100 | 10 |
| I-5 + tetflupyrolimet | 0.5 + 100 | 20 (E = 10) Δ = 10 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| tetflupyrolimet | 100 | 0 |
| I-5 + tetflupyrolimet | 2 + 100 | 20 (E = 10) Δ = 10 |
| I-5 + tetflupyrolimet | 0.5 + 100 | 10 (E = 0) Δ = 10 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| tiafenacil | 1 | 85 |
| I-5 + tiafenacil | 2 + 1 | 100 (E = 86.5) Δ = 13.5 |
| I-5 + tiafenacil | 0.5 + 1 | 100 (E = 85) Δ = 15 |

| | Application rate | Herbicidal efficacy [%] |
|---|---|---|
| Active ingredient | g a.i./ha | against SORHA 10 DAT |
| I-5 | 0.5 | 0 |
| tolpyralate | 2 | 85 |
| I-5 + tolpyralate | 0.5 + 2 | 90 (E = 85) Δ = 5 |

| | Application rate | Herbicidal efficacy [%] |
|---|---|---|
| Active ingredient | g a.i./ha | against SORHA 21 DAT |
| I-5 | 0.5 | 0 |
| tolpyralate | 2 | 50 |
| I-5 + tolpyralate | 0.5 + 2 | 60 (E = 50) Δ = 10 |

| | Application rate | Herbicidal efficacy [%] |
|---|---|---|
| Active ingredient | g a.i./ha | against SORHA 10 DAT |
| I-5 | 2 | 20 |
| | 0.5 | 0 |
| trifludimoxazin | 1 | 85 |
| | 0.25 | 70 |
| I-5 + trifludimoxazin | 2 + 1 | 100 (E = 88) Δ = 12 |
| | 2 + 0.25 | 88 (E = 76) Δ = 12 |
| | 0.5 + 1 | 100 (E = 85) Δ = 15 |

| | Application rate | Herbicidal efficacy [%] |
|---|---|---|
| Active ingredient | g a.i./ha | against SORHA 21 DAT |
| I-5 | 2 | 10 |
| | 0.5 | 0 |
| trifludimoxazin | 1 | 70 |
| | 0.25 | 40 |
| I-5 + trifludimoxazin | 2 + 1 | 100 (E = 73) Δ = 27 |
| | 2 + 0.25 | 80 (E = 46) Δ = 34 |
| | 0.5 + 1 | 100 (E = 70) Δ = 30 |

| | Application rate | Herbicidal efficacy [%] |
|---|---|---|
| Active ingredient | g a.i./ha | against XANST 21 DAT |
| I-5 | 2 | 20 |
| | 0.5 | 10 |
| benquitrione | 6 | 50 |
| I-5 + benquitrione | 2 + 6 | 75 (E = 60) Δ = 15 |
| I-5 + benquitrione | 0.5 + 6 | 60 (E = 55) Δ = 5 |

| | Application rate | Herbicidal efficacy [%] |
|---|---|---|
| Active ingredient | g a.i./ha | against XANST 10 DAT |
| I-5 | 2 | 30 |
| | 0.5 | 20 |
| fenpyrazone | 20 | 88 |
| I-5 + fenpyrazone | 2 + 20 | 97 (E = 91.6) Δ = 5.4 |
| I-5 + fenpyrazone | 0.5 + 20 | 95 (E = 90.4) Δ = 4.6 |

| | Application rate | Herbicidal efficacy [%] |
|---|---|---|
| Active ingredient | g a.i./ha | against XANST 21 DAT |
| I-5 | 2 | 20 |
| | 0.5 | 10 |
| fenpyrazone | 20 | 70 |
| I-5 + fenpyrazone | 2 + 20 | 95 (E = 76) Δ = 19 |
| I-5 + fenpyrazone | 0.5 + 20 | 90 (E = 73) Δ = 17 |

| | Application rate | Herbicidal efficacy [%] |
|---|---|---|
| Active ingredient | g a.i. / ha | against XANST 10 DAT |
| I-5 | 2 | 30 |
| | 0.5 | 20 |
| P1 | 0.3 | 60 |
| I-5 + P1 | 2 + 0.3 | 90 (E = 72) Δ = 18 |
| I-5 + P1 | 0.5 + 0.3 | 90 (E = 68) Δ = 22 |

| | Application rate | Herbicidal efficacy [%] |
|---|---|---|
| Active ingredient | g a.i. / ha | against XANST 21 DAT |
| I-5 | 2 | 20 |
| | 0.5 | 10 |
| P1 | 0.3 | 40 |
| I-5 + P1 | 2 + 0.3 | 85 (E = 52) Δ = 33 |
| I-5 + P1 | 0.5 + 0.3 | 85 (E = 46) Δ = 39 |

| | Application rate | Herbicidal efficacy [%] |
|---|---|---|
| Active ingredient | g a.i. / ha | against XANST 10 DAT |
| I-5 | 2 | 30 |
| | 0.5 | 20 |
| P2 | 0.3 | 20 |
| I-5 + P2 | 2 + 0.3 | 90 (E = 44) Δ = 46 |
| I-5 + P2 | 0.5 + 0.3 | 90 (E = 36) Δ = 54 |

| | Application rate | Herbicidal efficacy [%] |
|---|---|---|
| Active ingredient | g a.i. / ha | against XANST 21 DAT |
| I-5 | 2 | 20 |
| | 0.5 | 10 |
| P2 | 0.3 | 10 |
| I-5 + P2 | 2 + 0.3 | 60 (E = 28) Δ = 32 |
| I-5 + P2 | 0.5 + 0.3 | 30 (E = 19) Δ = 11 |

| | Application rate | Herbicidal efficacy [%] |
|---|---|---|
| Active ingredient | g a.i. / ha | against XANST 10 DAT |
| I-5 | 0.5 | 20 |
| tiafenacil | 1 | 88 |
| I-5 + tiafenacil | 0.5 + 1 | 100 (E = 90.4) Δ = 9.6 |

| | Application rate | Herbicidal efficacy [%] |
|---|---|---|
| Active ingredient | g a.i. / ha | against XANST 21 DAT |
| I-5 | 0.5 | 10 |
| tiafenacil | 1 | 85 |
| I-5 + tiafenacil | 0.5 + 1 | 95 (E = 86.5) Δ = 8.5 |

| | Application rate | Herbicidal efficacy [%] |
|---|---|---|
| Active ingredient | g a.i. / ha | against XANST 21 DAT |
| I-5 | 2 | 20 |
| | 0.5 | 10 |
| tolpyralate | 2 | 70 |
| | 0.5 | 30 |
| I-5 + tolpyralate | 2 + 2 | 85 (E = 76) Δ = 9 |
| | 2 + 0.5 | 80 (E = 44) Δ = 36 |
| | 0.5 + 2 | 88 (E = 73) Δ = 15 |

| | Application rate | Herbicidal efficacy [%] |
|---|---|---|
| Active ingredient | g a.i. / ha | against EMEAU 10 DAT |
| I-5 | 0.5 | 30 |
| flufenoximacil | 0.00625 | 50 |
| I-5 & flufenoximacil | 0.5 + 0.00625 | 80 (E = 65) Δ = 15 |

| | Application rate | Herbicidal efficacy [%] |
|---|---|---|
| Active ingredient | g a.i. / ha | against EMEAU 21 DAT |
| I-5 | 2 | 88 |
| I-5 | 0.5 | 20 |
| flufenoximacil | 0.00625 | 10 |
| I-5 & flufenoximacil | 2 + 0.00625 | 97 (E = 89.2) Δ = 7.8 |
| | 0.5 + 0.00625 | 70 (E = 28) Δ = 42 |

| | Application rate | Herbicidal efficacy [%] |
|---|---|---|
| Active ingredient | g a.i. / ha | against EPHHL 21 DAT |
| I-5 | 2 | 40 |
| I-5 | 0.5 | 30 |
| flufenoximacil | 0.025 | 88 |
| flufenoximacil | 0.00625 | 40 |
| BCS-DC31848 & | 2 + 0.025 | 100 (E = 92.8) Δ = 7.2 |
| flufenoximacil | 2 + 0.00625 | 70 (E = 64) Δ = 6 |
| | 0.5 + 0.025 | 100 (E = 91.6) Δ = 8.4 |
| | 0.5 + 0.00625 | 70 (E = 58) Δ = 12 |

| | Application rate | Herbicidal efficacy [%] |
|---|---|---|
| Active ingredient | g a.i. / ha | against ERIBO 21 DAT |
| I-5 | 2 | 40 |
| flufenoximacil | 0.1 | 60 |
| flufenoximacil | 0.025 | 40 |
| I-5 & flufenoximacil | 2 + 0.1 | 97 (E = 76) Δ = 21 |
| | 2 + 0.025 | 85 (E = 64) Δ = 21 |

| | Application rate | Herbicidal efficacy [%] |
|---|---|---|
| Active ingredient | g a.i. / ha | against PHBPU 21 DAT |
| I-5 | 0.5 | 40 |
| flufenoximacil | 0.025 | 75 |
| I-5 & flufenoximacil | 0.5 + 0.025 | 99 (E = 85) Δ = 14 |

| | Application rate | Herbicidal efficacy [%] |
|---|---|---|
| Active ingredient | g a.i. / ha | against POLCO 21 DAT |
| I-5 | 2 | 30 |
| flufenoximacil | 0.025 | 60 |
| I-5 & flufenoximacil | 2 + 0.025 | 100 (E = 72) Δ = 28 |

| | Application rate | Herbicidal efficacy [%] |
|---|---|---|
| Active ingredient | g a.i. / ha | against SORHA 10 DAT |
| I-5 | 2 | 90 |
| flufenoximacil | 0.00625 | 20 |
| I-5 & flufenoximacil | 2 + 0.00625 | 97 (E = 92) Δ = 5 |

| | Application rate | Herbicidal efficacy [%] |
|---|---|---|
| Active ingredient | g a.i. / ha | against XANST 21 DAT |
| I-5 | 0.5 | 30 |
| flufenoximacil | 0.00625 | 10 |
| I-5 & flufenoximacil | 0.5 + 0.00625 | 85 (E = 37) Δ = 48 |

1. An herbicidal composition comprising:
(A) a compound having an absolute configuration (component A) specified in formula (I-5) or salts thereof 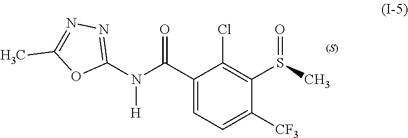
and;
(B) one or more herbicides (component B) selected from groups B1, B2, B5, B6, B8 and B9:
wherein B1 is one of dioxopyritrione, benquitrione, tolpyralate, and lancotrione,
wherein B2 is one of methyl (2R*,4R*)-4-[[(5S)-3-(3,5-difluorophenyl)-5-vinyl-4H-isoxazole-5-carbonyl]amino]tetrahydrofuran-2-carboxylate, methyl (1S,4R)-4-[[(5S)-3-(3,5-difluorophenyl)-5-vinyl-4H-isoxazole-5-carbonyl]amino]cyclopent-2-ene-1-carboxylate, and dimesulfacet,
wherein B5 is one of trifludimoxazin, tetflupyrolimet, fenpyrazone, florpyrauxifen, and bixlozone,
wherein B6 is 4-amino-3-chloro-5-fluoro-6-(7-fluoro-1H-indol-6-yl)pyridine-2-carboxylic acid,
wherein B8 is rimisoxafen, and
wherein B9 is one of tiafenacil, flufenoximacil, and ethyl 3-{2-chloro-4-fluoro-5-[3-methyl-2,6-dioxo-4-(trifluoromethyl)-3,6-dihydropyrimidin-1(2H)-yl]phenyl}-5-methyl-4,5-dihydro-1,2-oxazole-5-carboxylate.

2. The herbicidal composition according to claim 1,
wherein B1 is one of dioxopyritrione, benquitrione, and tolpyralate,
wherein B2 is one of methyl (2R*,4R*)-4-[[(5S)-3-(3,5-difluorophenyl)-5-vinyl-4H-isoxazole-5-carbonyl]amino]tetrahydrofuran-2-carboxylate, and methyl (1S,4R)-4-[[(5S)-3-(3,5-difluorophenyl)-5-vinyl-4H-isoxazole-5-carbonyl]amino]cyclopent-2-ene-1-carboxylate.

3. The herbicidal composition according to claim 2,
wherein B5 is one of trifludimoxazin, tetflupyrolimet, fenpyrazone and florpyrauxifen.

4. The herbicidal composition according to claim 1, additionally comprising, as component C, one or more safeners selected from the group consisting of benoxacor, cloquintocet-mexyl, cyprosulfamide, dichlormid, fenclorim, fenchlorazole, furilazole, isoxadifen-ethyl, mefenpyr-diethyl, 4-(dichloroacetyl)-1-oxa-4-azaspiro[4.5]decane, 2,2,5-trimethyl-3-(dichloroacetyl)-1,3-oxazolidine.

5. A method of controlling unwanted plants in crops, the method comprising application of a herbicidally active amount of a herbicidal composition according to claim 1 to the unwanted plants, crop plants, crop plant seeds or an area on which the crop plants grow.

6. The method according to claim 5, wherein the crop plants are selected from the group consisting of sugar cane, corn, wheat, rye, barley, oats, rice, sorghum, cotton and soya.

7. The method according to claim 5, wherein the crop plants have been genetically modified.
